(19) United States
(12) Patent Application Publication
(10) Pub. No.: US 2025/0114264 A1
(43) Pub. Date: Apr. 10, 2025

(54) INFLATABLE SYSTEM, PATIENT TREATMENT SYSTEM, SHOCK TREATMENT SYSTEM, PROCESS, AND METHOD OF USE

(71) Applicant: Paul L. Kramer, Olathe, KS (US)

(72) Inventor: Paul L. Kramer, Olathe, KS (US)

(21) Appl. No.: 18/635,138

(22) Filed: Apr. 15, 2024

Related U.S. Application Data
(60) Provisional application No. 63/459,729, filed on Apr. 17, 2023.

(51) Int. Cl. A61G 13/12

(52) U.S. Cl. CPC A61G 13/1265

(57) ABSTRACT

An inflatable system, a patient treatment system, a shock treatment system, processes and methods of use are presented. The present disclosure is an inflatable device for use in treatment of a patient. More specifically, and without limitation, the disclosure is an inflatable device for treating a patient in medical shock and/or in need of circulation assistance. The present disclosure provides for ease of operation and quick assistance in raising the legs and/or elevating lower extremities of patients for circulation purposes and the like.

### CROSS-REFERENCE TO RELATED APPLICATIONS

The present application claims priority to the U.S. Provisional Patent Application No. 63/459,729 which was filed on Apr. 17, 2023, which is hereby incorporated by reference herein in its entirety, including any figures, tables, or drawings.

### FIELD OF THE DISCLOSURE

This disclosure relates to an inflatable system, a patient treatment system, a shock treatment system, processes and methods of use. More specifically, and without limitation, the present disclosure relates to an inflatable one-time use device used in the medical treatment of a patient in shock. More specifically, and without limitation, the present disclosure relates to an inflatable one-time use device used in the medical treatment of a patient in need of appendage elevation.

### COPYRIGHT NOTICE

At least a portion of the disclosure of this patent document contains material that is subject to copyright protection. The copyright owner has no objection to the facsimile reproduction by anyone of the patent document or the patent disclosure, as it appears in the Patent and Trademark Office patent files and/or records, but otherwise reserves all copyright rights whatsoever. The following notice applies to the software and data as described below and in the drawings that form a part of this document. Copyright Dr. Paul L. Kramer. All rights reserved.

### BACKGROUND OF THE DISCLOSURE

Shock is a well known medical condition. This condition is a very serious medical condition generally brought on by the sudden drop in blood flow throughout the body. A shock state results in poor perfusion of the bodies organs. Shock is critical and can be very dangerous, and in some cases cause irreversible harm or even death. Shock can result from trauma, heart attack, heatstroke, blood loss, an allergic reaction, severe infection, poisoning, burns, or other causes. The lack of blood flow can cause a deprivation of blood and/or oxygen to vital organs, or organs in general.

One known medical treatment for shock patients is passive leg raise (PLR). The goal in PLR, or elevating limbs or legs, is to encourage venous circulation to be shunted to the body core. Primarily, the purpose of raising limbs, such as legs, forces blood flow to the core. This forces blood flow to vital organs such as the brain, heart, lungs, and kidneys. This shunted venous blood not only can cause organ perfusion but also has the ability to provide nutrient exchange (which IV fluids do not). It does this by providing oxygen and removing carbon dioxide to these deprived core organ areas, in some cases PLR can increase core circulation of blood flow throughout the body, which can also lead to the end of the shock. However, the current onsite treatment in the state of the art is through IV fluids. This treatment poses many problems, such as contributing to hypothermia (fluids are usually about 70 degrees). Furthermore, IV fluids are not able to offer nutrient exchange.

Motor vehicle accidents (MVA) are a common cause of shock due to trauma, around the globe. MVAs are a leading cause of death and injury in the United States. Oftentimes trauma patients at a car crash suffer from shock. This means that many cases of shock occur in remote locations, away from hospitals and/or in locations of emergency. Furthermore, trained professionals are often limited in number. This limits the ability of those medical personnel to function if they are utilized for limb raising or elevation.

Raising of one's limbs also serves other medical purposes. For example, swollen limbs can be raised as a treatment for managing this swelling. The goal in this case is to elevate a limb above the height of the heart. This helps extra fluid move back toward the heart, thus aiding in circulation throughout the body. Rest, ice, compression, and elevation (“RICE”), is another known treatment for reducing swelling and the like due to elevation of a limb or appendage.

Thus, there is a need in the art for a portable, lightweight and/or simple to operate, efficient, fast, reliable means for elevating appendage(s) of a patient. This is especially true in emergency, remote locations, in addition to hospitals, emergency rooms, and the like.

The disclosure herein provides these advantages and others as will become clear from the specification and claims provided.

### SUMMARY OF THE DISCLOSURE

An inflatable system, a patient treatment system, a shock treatment system, processes and methods of use. Said another way, the present disclosure relates to an inflatable one-time use device used in the medical treatment of a patient in shock. Said another way, the present disclosure relates to an inflatable one-time use device used in the medical treatment of a patient in need of appendage elevation.

Thus, the present disclosure provides the state of the art with an easy, efficient, fast, reliable means for elevating appendage(s) of a patient. This is especially true in emergency, remote locations, in addition to hospitals, emergency rooms, and the like.

Thus, it is a primary object of the disclosure to provide an inflatable system, a patient treatment system, a shock treatment system, processes and methods of use that improves upon the state of the art and offers a new medical system.

Another object of the disclosure is to provide an inflatable system, a patient treatment system, a shock treatment system, processes and methods of use that provides an inflatable one-time use device.

Yet another object of the disclosure is to provide an inflatable system, a patient treatment system, a shock treatment system, processes and methods of use that provides an inflatable device for medical treatment of a patient.

Another object of the disclosure is to provide an inflatable system, a patient treatment system, a shock treatment system, processes and methods of use that provides an inflatable device for use in the medical treatment of a patient in shock.

Yet another object of the disclosure is to provide an inflatable system, a patient treatment system, a shock treatment system, processes and methods of use that provides for medical treatment of a patient needing appendage elevation.

Another object of the disclosure is to provide an inflatable system, a patient treatment system, a shock treatment system, processes and methods of use that provides an inflatable one-time use device for medical treatment of a patient in shock.

Yet another object of the disclosure is to provide an inflatable system, a patient treatment system, a shock treatment system, processes and methods of use that are portable.

Another object of the disclosure is to provide an inflatable system, a patient treatment system, a shock treatment system, processes and methods of use that are safe to use.

Yet another object of the disclosure is to provide an inflatable system, a patient treatment system, a shock treatment system, processes and methods of use that are safe to use at an emergency location.

Another object of the disclosure is to provide an inflatable system, a patient treatment system, a shock treatment system, processes and methods of use that is easily portable and can be handled by a single user.

Yet another object of the disclosure is to provide an inflatable system, a patient treatment system, a shock treatment system, processes and methods of use that are fast.

Another object of the disclosure is to provide an inflatable system, a patient treatment system, a shock treatment system, processes and methods of use that are fast to inflate and utilize.

Yet another object of the disclosure is to provide an inflatable system, a patient treatment system, a shock treatment system, processes and methods of use that can be inflated and utilized in seconds.

Another object of the disclosure is to provide an inflatable system, a patient treatment system, a shock treatment system, processes and methods of use that are efficient.

Yet another object of the disclosure is to provide an inflatable system, a patient treatment system, a shock treatment system, processes and methods of use that are efficient at increasing blood circulation.

Another object of the disclosure is to provide an inflatable system, a patient treatment system, a shock treatment system, processes and methods of use that decrease morbidity rates in patent shock.

Yet another object of the disclosure is to provide an inflatable system, a patient treatment system, a shock treatment system, processes and methods of use that decrease mortality rates in patient shock.

Another object of the disclosure is to provide an inflatable system, a patient treatment system, a shock treatment system, processes and methods of use that utilize a gas cartridge.

Yet another object of the disclosure is to provide an inflatable system, a patient treatment system, a shock treatment system, processes and methods of use that utilize an inflation cartridge for rapid inflation.

Another object of the disclosure is to provide an inflatable system, a patient treatment system, a shock treatment system, processes and methods of use that support and elevate the lower extremities of a patient.

Yet another object of the disclosure is to provide an inflatable system, a patient treatment system, a shock treatment system, processes and methods of use that successfully initiate, and rapidly initiate, passive leg raise in a patient.

Another object of the disclosure is to provide an inflatable system, a patient treatment system, a shock treatment system, processes and methods of use that mobilize venous blood volume.

Yet another object of the disclosure is to provide an inflatable system, a patient treatment system, a shock treatment system, processes and methods of use that increases core circulation of blood volume.

Another object of the disclosure is to provide an inflatable system, a patient treatment system, a shock treatment system, processes and methods of use that increase core circulation of blood volume with nutrient carrying capacity.

Yet another object of the disclosure is to provide an inflatable system, a patient treatment system, a shock treatment system, processes and methods of use that can adjust to different pressures, releasing pressure for various heights and sizes.

Another object of the disclosure is to provide an inflatable system, a patient treatment system, a shock treatment system, processes and methods of use that tracks historical data of activation time, geographic location, and the like.

Yet another object of the disclosure is to provide an inflatable system, a patient treatment system, a shock treatment system, processes and methods of use that is secure during patient transport and/or extraction.

Another object of the disclosure is to provide an inflatable system, a patient treatment system, a shock treatment system, processes and methods of use that assists in patient transport and/or extraction.

Yet another object of the disclosure is to provide an inflatable system, a patient treatment system, a shock treatment system, processes and methods of use that provides written instructions on the device for ease of use and clear instructions.

Another object of the disclosure is to provide an inflatable system, a patient treatment system, a shock treatment system, processes and methods of use that provides sizing charts and information.

Yet another object of the disclosure is to provide an inflatable system, a patient treatment system, a shock treatment system, processes and methods of use that includes predetermined calculations for patients of different sizes.

Another object of the disclosure is to provide an inflatable system, a patient treatment system, a shock treatment system, processes and methods of use that provides a carbon dioxide (CO2) cartridge.

Yet another object of the disclosure is to provide an inflatable system, a patient treatment system, a shock treatment system, processes and methods of use that includes a pre-loaded and pre-charged carbon dioxide (CO2) cartridge, for inflation.

Another object of the disclosure is to provide an inflatable system, a patient treatment system, a shock treatment system, processes and methods of use that are semi-rigid.

Yet another object of the disclosure is to provide an inflatable system, a patient treatment system, a shock treatment system, processes and methods of use that fits comfortably under the legs of a patient.

Another object of the disclosure is to provide an inflatable system, a patient treatment system, a shock treatment system, processes and methods of use that elevates the lower extremities of a patient.

Yet another object of the disclosure is to provide an inflatable system, a patient treatment system, a shock treatment system, processes and methods of use that structurally supports the lower extremities of a patient.

Another object of the disclosure is to provide an inflatable system, a patient treatment system, a shock treatment system, processes and methods of use that secures the lower extremities of a patient in place.

Yet another object of the disclosure is to provide an inflatable system, a patient treatment system, a shock treatment system, processes and methods of use that increases blood flow of a patient.

Another object of the disclosure is to provide an inflatable system, a patient treatment system, a shock treatment system, processes and methods of use that increases available nutrients to vital organs.

Yet another object of the disclosure is to provide an inflatable system, a patient treatment system, a shock treatment system, processes and methods of use that is made from a nylon airtight container.

Another object of the disclosure is to provide an inflatable system, a patient treatment system, a shock treatment system, processes and methods of use that are available in different size options.

Yet another object of the disclosure is to provide an inflatable system, a patient treatment system, a shock treatment system, processes and methods of use that are adjustable for different sizing needs and applications.

Another object of the disclosure is to provide an inflatable system, a patient treatment system, a shock treatment system, processes and methods of use that is lightweight.

Yet another object of the disclosure is to provide an inflatable system, a patient treatment system, a shock treatment system, processes and methods of use that includes an easy to use trigger mechanism.

Another object of the disclosure is to provide an inflatable system, a patient treatment system, a shock treatment system, processes and methods of use that can be deflated and reused.

Yet another object of the disclosure is to provide an inflatable system, a patient treatment system, a shock treatment system, processes and methods of use that are disposable.

Another object of the disclosure is to provide an inflatable system, a patient treatment system, a shock treatment system, processes and methods of use that are compact.

Yet another object of the disclosure is to provide an inflatable system, a patient treatment system, a shock treatment system, processes and methods of use that can be used by EMS, military, emergency personnel, emergency rooms, hospitals, operating rooms, intensive care units, and the like.

Another object of the disclosure is to provide an inflatable system, a patient treatment system, a shock treatment system, processes and methods of use that includes handholds.

Yet another object of the disclosure is to provide an inflatable system, a patient treatment system, a shock treatment system, processes and methods of use that includes a replaceable CO2 cartridge slot.

Another object of the disclosure is to provide an inflatable system, a patient treatment system, a shock treatment system, processes and methods of use that can be used for patient stabilization.

Yet another object of the disclosure is to provide an inflatable system, a patient treatment system, a shock treatment system, processes and methods of use that can be used as a flotation device.

Another object of the disclosure is to provide an inflatable system, a patient treatment system, a shock treatment system, processes and methods of use that can be used in rehabilitation.

Yet another object of the disclosure is to provide an inflatable system, a patient treatment system, a shock treatment system, processes and methods of use that can form a variety of shapes, such as but not limited to, a rhomboid, hexagon, circle, tube, square, and the like.

Another object of the disclosure is to provide an inflatable system, a patient treatment system, a shock treatment system, processes and methods of use that conforms to various placement options as as below the knee, calf, elbow, hips, head, and the like.

Yet another object of the disclosure is to provide an inflatable system, a patient treatment system, a shock treatment system, processes and methods of use that includes hook and loop strap.

Another object of the disclosure is to provide an inflatable system, a patient treatment system, a shock treatment system, processes and methods of use that can be used to secure a gurney, back board, mega mover sheet and the like.

Yet another object of the disclosure is to provide an inflatable system, a patient treatment system, a shock treatment system, processes and methods of use that includes a built in adhesive for structural stabilization.

Another object of the disclosure is to provide an inflatable system, a patient treatment system, a shock treatment system, processes and methods of use that can be used for head stabilization.

Yet another object of the disclosure is to provide an inflatable system, a patient treatment system, a shock treatment system, processes and methods of use that includes a built-in transfer sheet.

Another object of the disclosure is to provide an inflatable system, a patient treatment system, a shock treatment system, processes and methods of use that are cost effective and relatively affordable.

Yet another object of the disclosure is to provide an inflatable system, a patient treatment system, a shock treatment system, processes and methods of use that are easy to use.

Another object of the disclosure is to provide an inflatable system, a patient treatment system, a shock treatment system, processes and methods of use that provide easy use for non medical professionals.

Yet another object of the disclosure is to provide an inflatable system, a patient treatment system, a shock treatment system, processes and methods of use that includes global positioning systems.

Another object of the disclosure is to provide an inflatable system, a patient treatment system, a shock treatment system, processes and methods of use that are easy to use.

Yet another object of the disclosure is to provide an inflatable system, a patient treatment system, a shock treatment system, processes and methods of use that are safe to use.

Another object of the disclosure is to provide an inflatable system, a patient treatment system, a shock treatment system, processes and methods of use that save time for a user.

Yet another object of the disclosure is to provide an inflatable system, a patient treatment system, a shock treatment system, processes and methods of use that are robust.

Another object of the disclosure is to provide an inflatable system, a patient treatment system, a shock treatment system, processes and methods of use that free up a user's hands for other functions.

Yet another object of the disclosure is to provide an inflatable system, a patient treatment system, a shock treatment system, processes and methods of use that are high quality.

These and other objects, features, or advantages of the present disclosure will become apparent from the specification and claims.

### BRIEF DESCRIPTION OF THE DRAWINGS

The drawings accompanying and forming part of this specification are included to depict certain aspects of the disclosure.

FIG. 1 is a top, perspective view of the system; the view showing the main body having a membrane; the view showing the main body extending a length from a first end to a second end between opposing sides, having a top and a bottom; the view showing a first groove; the view showing a second groove; the view showing a first support; the view showing a second support; the view showing a spacer.

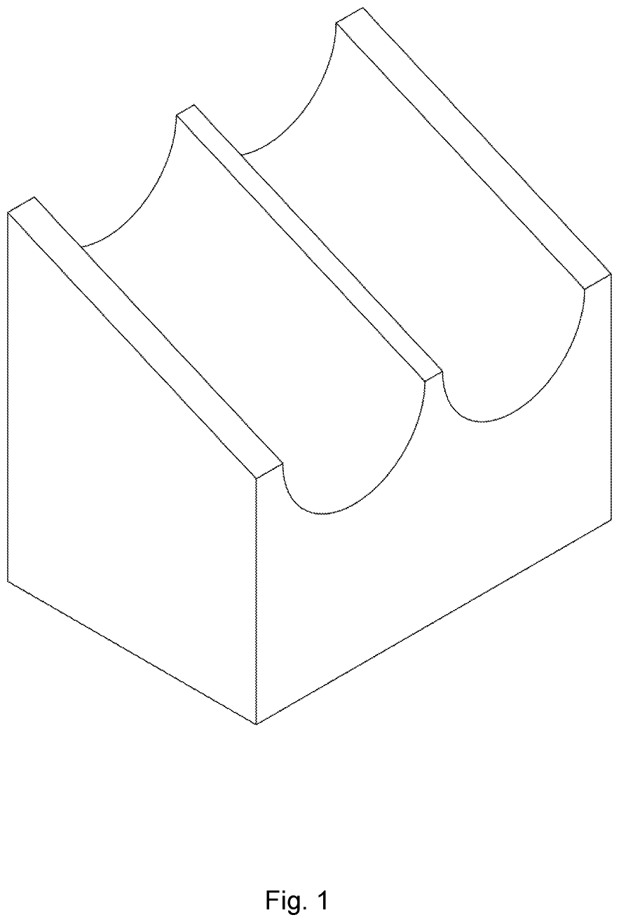

FIG. 2 is a top, perspective view of the system; the view showing the main body having a membrane; the view showing the main body extending a length from a first end to a second end between opposing sides, having a top and a bottom; the view showing a first groove; the view showing a second groove; the view showing a first support; the view showing a second support; the view showing a spacer.

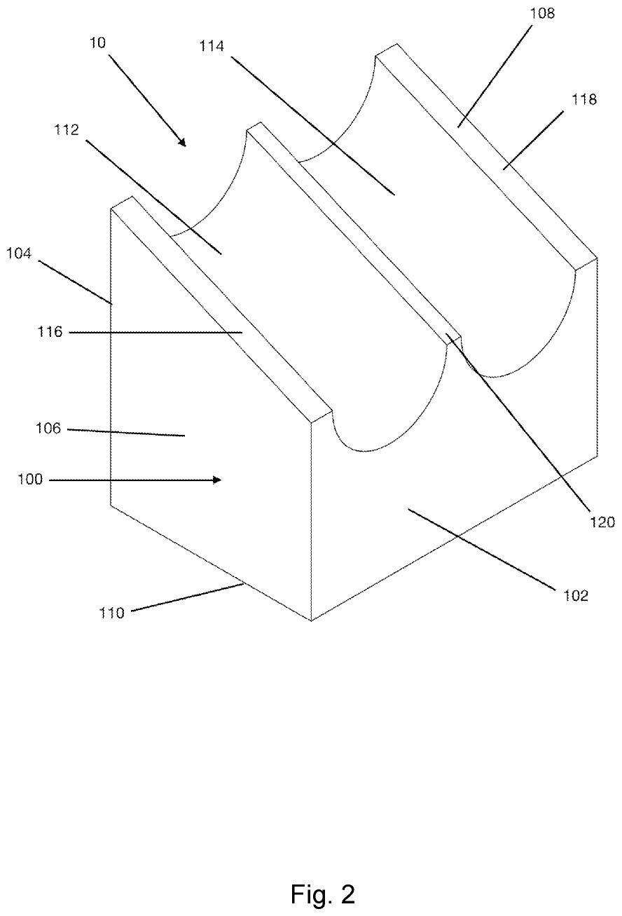

FIG. 3 is a front view of the system; the view showing the main body having a membrane; the view showing the main body extending a length from a first end to a second end between opposing sides, having a top and a bottom; the view showing a first groove; the view showing a second groove; the view showing a first support; the view showing a second support; the view showing a spacer.

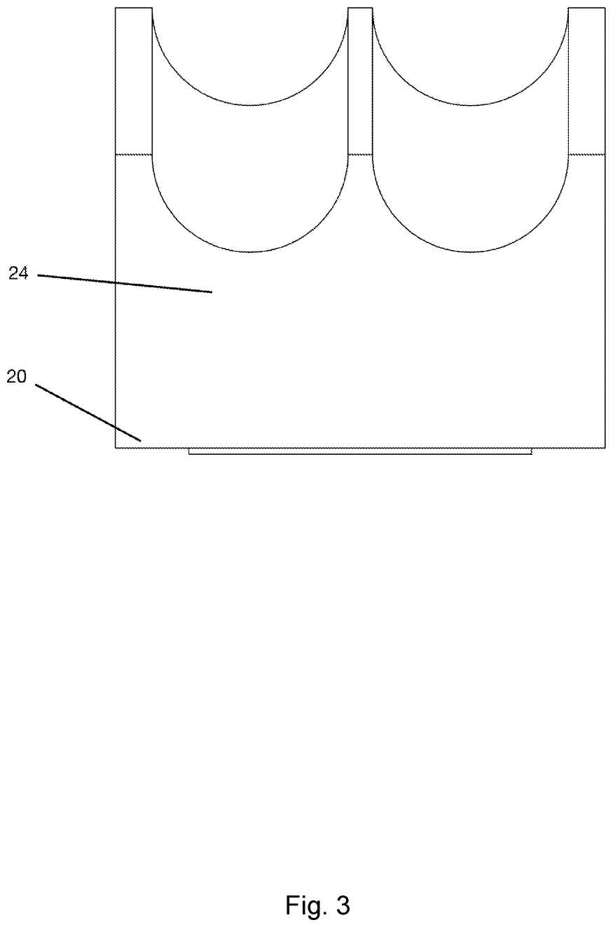

FIG. 4 is a rear view of the system; the view showing the main body having a membrane; the view showing the main body extending a length from a first end to a second end between opposing sides, having a top and a bottom; the view showing a first groove; the view showing a second groove; the view showing a first support; the view showing a second support; the view showing a spacer.

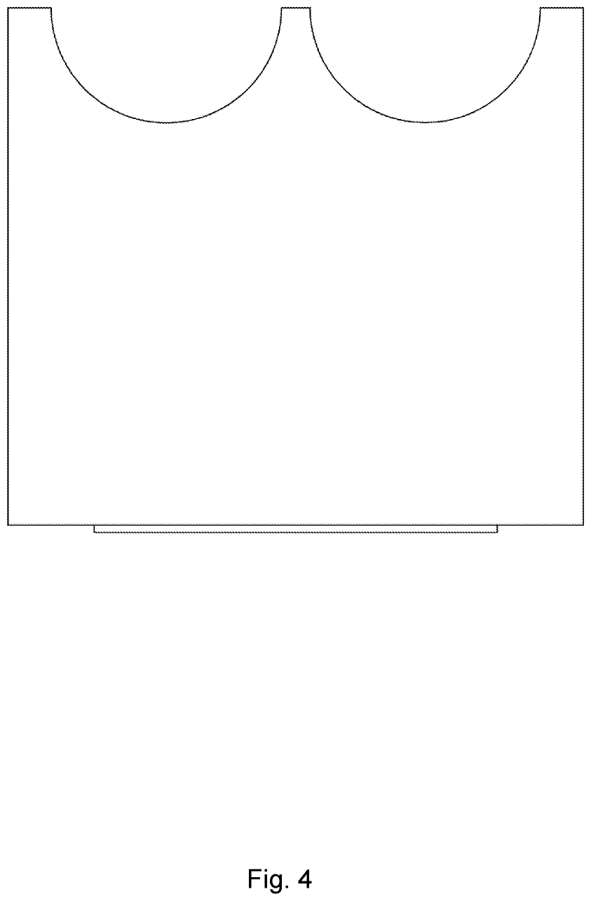

FIG. 5 is a top view of the system; the view showing the main body having a membrane; the view showing the main body extending a length from a first end to a second end between opposing sides, having a top and a bottom; the view showing a first groove; the view showing a second groove; the view showing a first support; the view showing a second support; the view showing a spacer.

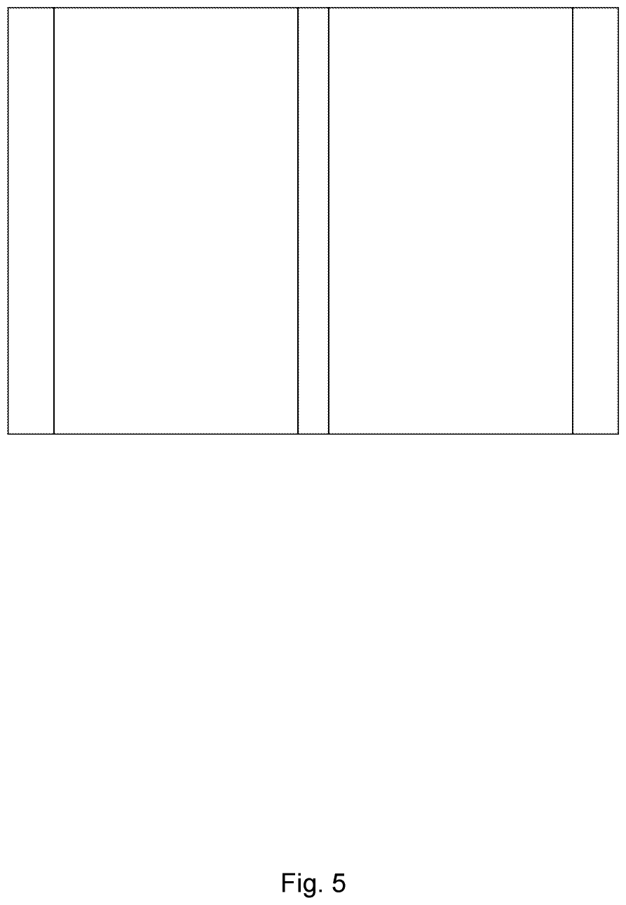

FIG. 6 is a bottom view of the system; the view showing the main body having a membrane; the view showing the main body extending a length from a first end to a second end between opposing sides.

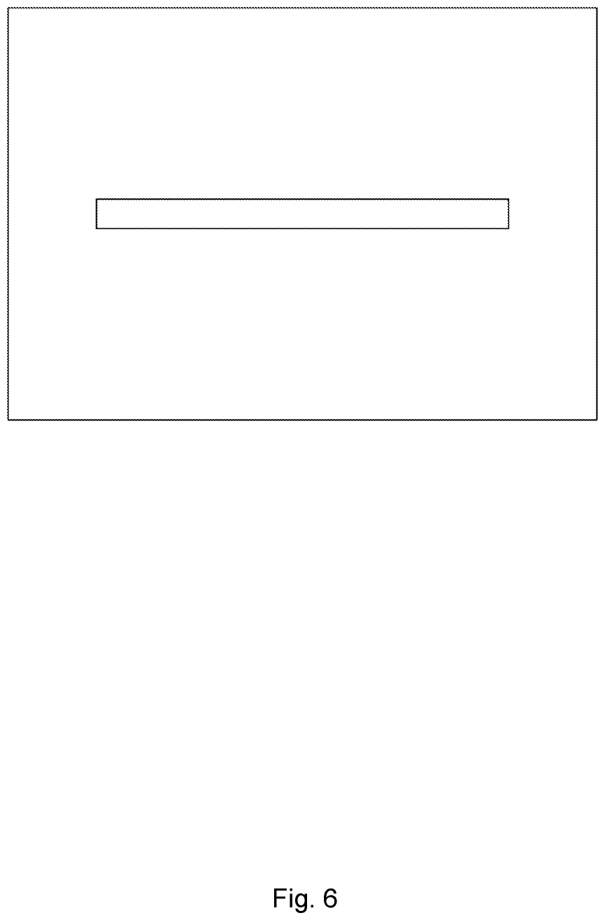

FIG. 7 is a side view of the system; the view showing the main body having a membrane; the view showing the main body extending a length from a first end to a second end between opposing sides.

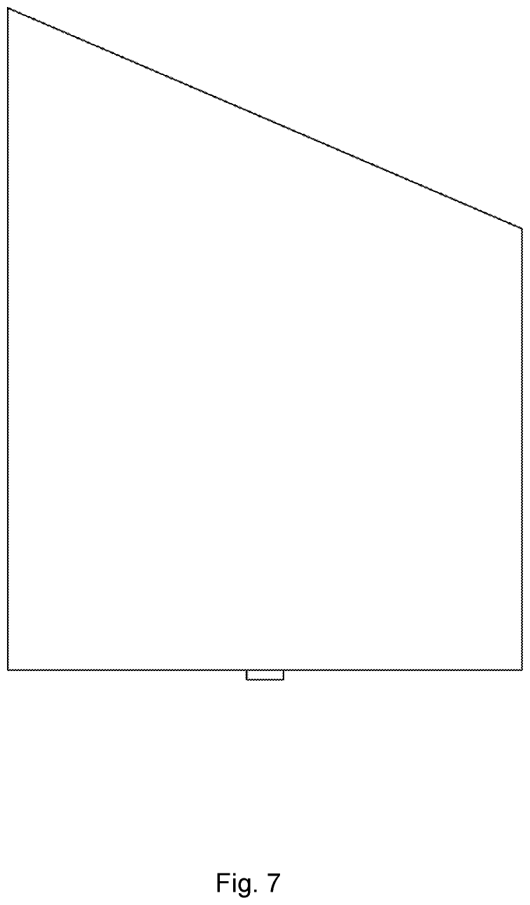

FIG. 8 is a side view of the system; the view showing the main body having a membrane; the view showing the main body extending a length from a first end to a second end between opposing sides.

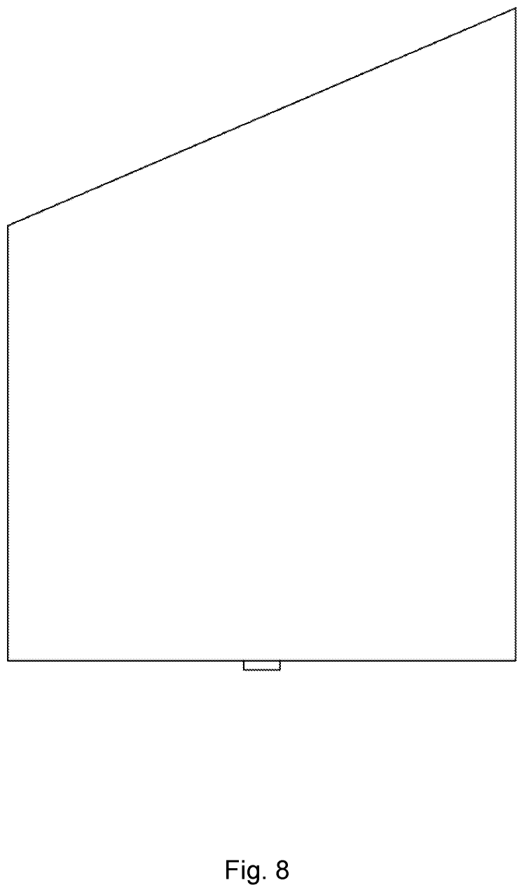

FIG. 9 is a bottom, perspective view of the system; the view showing the main body having a membrane; the view showing the main body extending a length from a first end to a second end between opposing sides, having a top and a bottom; the view showing a first groove; the view showing a second groove; the view showing a first support; the view showing a second support; the view showing a spacer.

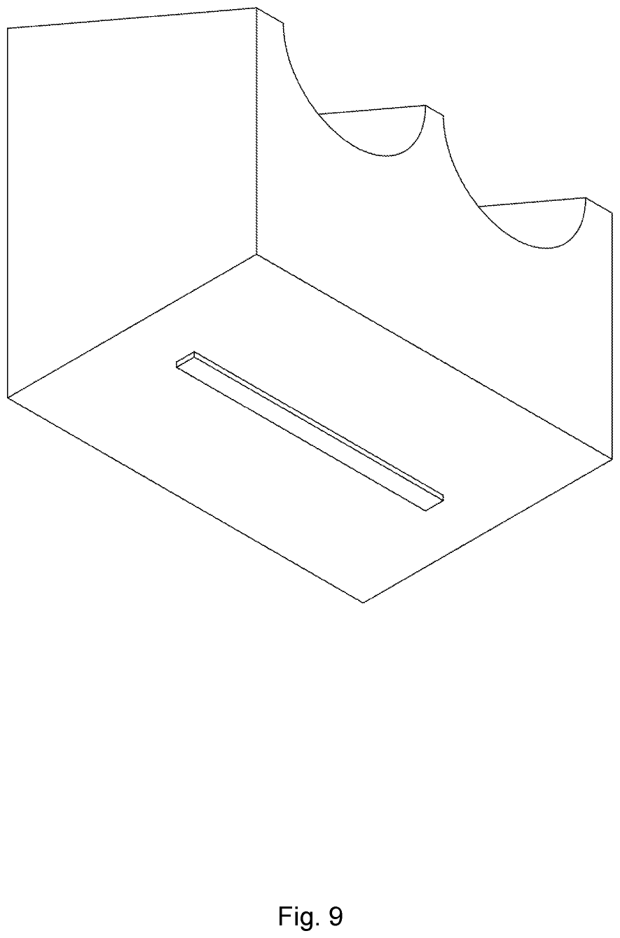

FIG. 10 is a top, perspective view of the system; the view showing the main body having a membrane; the view showing the main body extending a length from a first end to a second end between opposing sides, having a top and a bottom; the view showing a first groove; the view showing a second groove; the view showing a first support; the view showing a second support; the view showing a spacer; the view showing a display; the view showing securement straps; the view showing hook and loop securement; the view showing handholds.

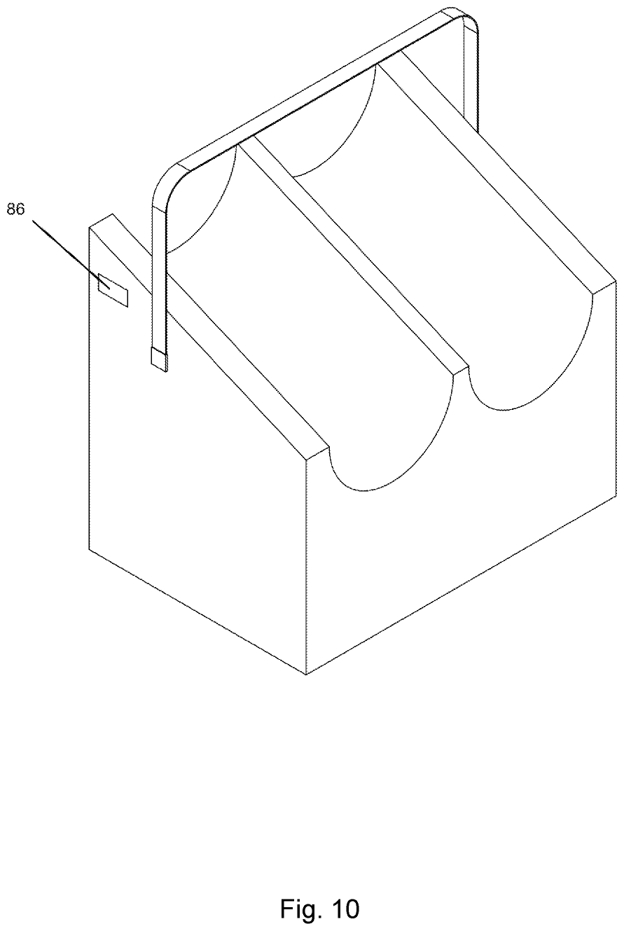

FIG. 11 is a front view of the system; the view showing the main body having a membrane; the view showing the main body extending a length from a first end to a second end between opposing sides, having a top and a bottom; the view showing a first groove; the view showing a second groove; the view showing a first support; the view showing a second support; the view showing a spacer; the view showing a vital detection feature; the view showing a chamber holding an inflatable gas and/or compressed gas.

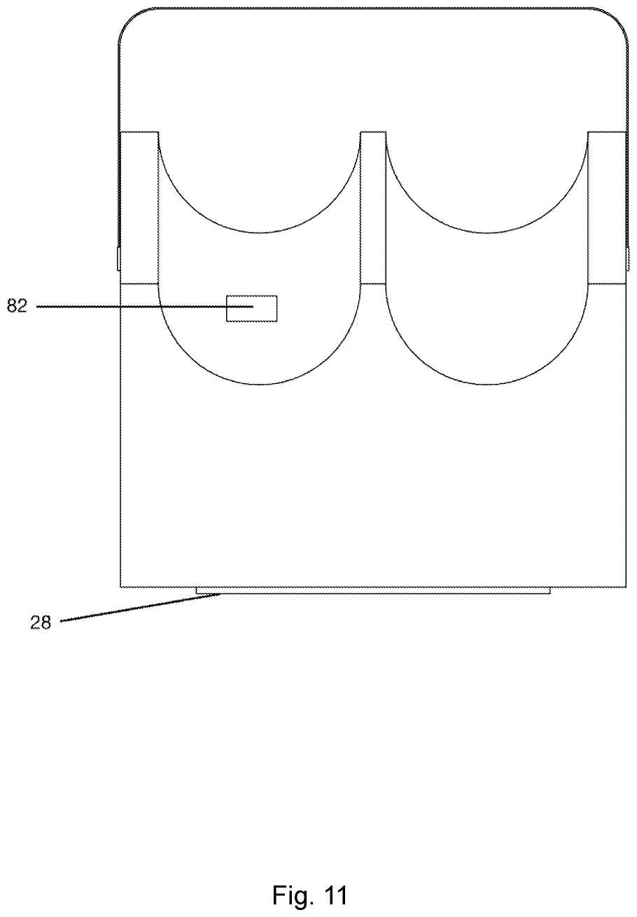

FIG. 12 is a rear view of the system; the view showing the main body having a membrane; the view showing the main body extending a length from a first end to a second end between opposing sides, having a top and a bottom; the view showing a first groove; the view showing a second groove; the view showing a first support; the view showing a second support; the view showing a spacer.

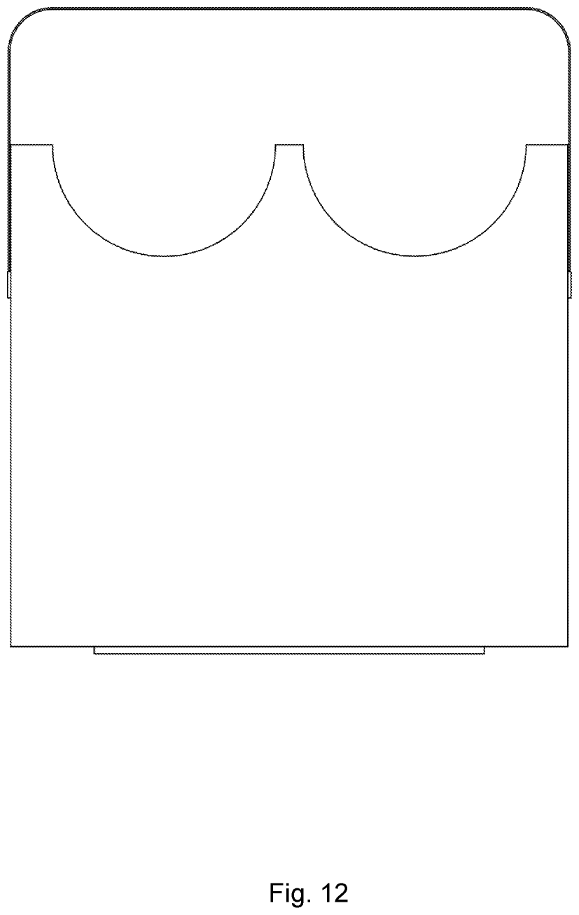

FIG. 13 is a top view of the system; the view showing the main body having a membrane; the view showing the main body extending a length from a first end to a second end between opposing sides, having a top and a bottom; the view showing a first groove; the view showing a second groove; the view showing a first support; the view showing a second support; the view showing a spacer; the view showing a securement strap.

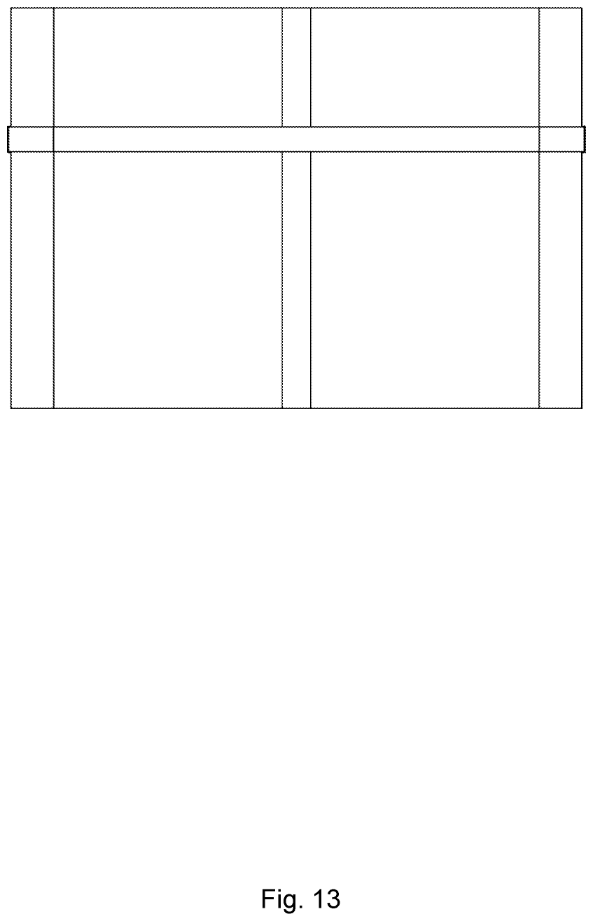

FIG. 14 is a bottom, perspective view of the system; the view showing the main body having a membrane; the view showing the main body extending a length from a first end to a second end between opposing sides, having a top and a bottom; the view showing a first groove; the view showing a second groove; the view showing a first support; the view showing a second support; the view showing a spacer; the view showing an activation feature having an activation and a deactivation; the view showing a GPS feature.

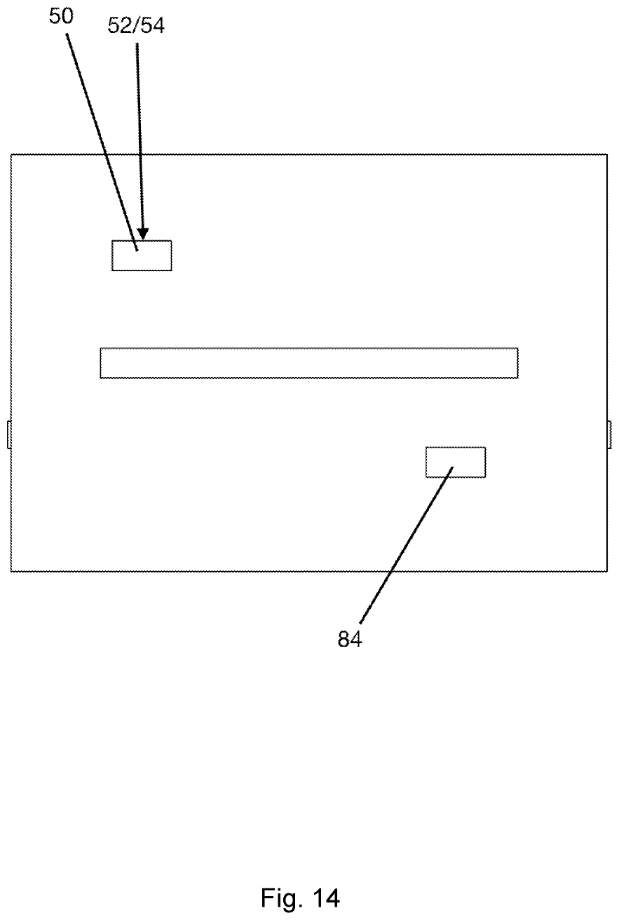

FIG. 15 is a side view of the system; the view showing the main body having a membrane; the view showing the main body extending a length from a first end to a second end between opposing sides; the view showing a display; the view showing a securement strap; the view showing a handhold; the view showing a hook and loop fastener.

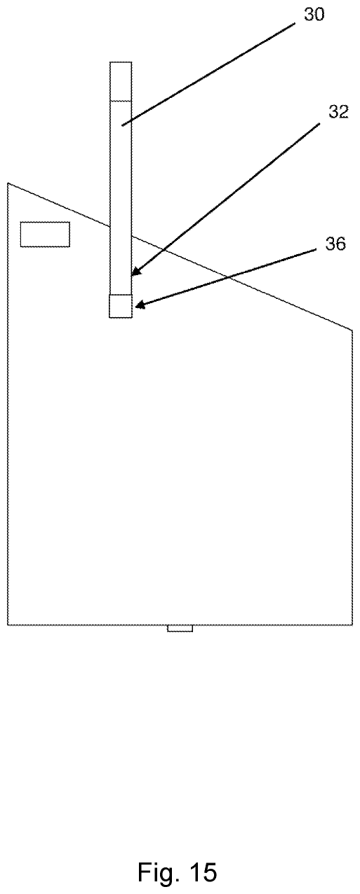

FIG. 16 is a side view of the system; the view showing the main body having a membrane; the view showing the main body extending a length from a first end to a second end between opposing sides; the view showing an activation feature having a pull string; the view showing an inflation port.

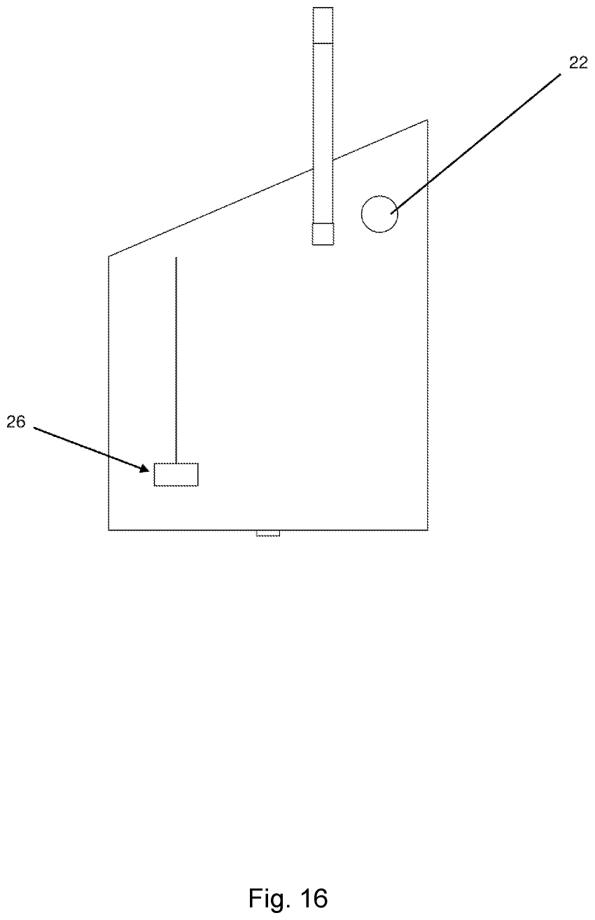

FIG. 17 is a bottom, perspective view of the system; the view showing the main body having a membrane; the view showing the main body extending a length from a first end to a second end between opposing sides, having a top and a bottom; the view showing a first groove; the view showing a second groove; the view showing a first support; the view showing a second support; the view showing a spacer.

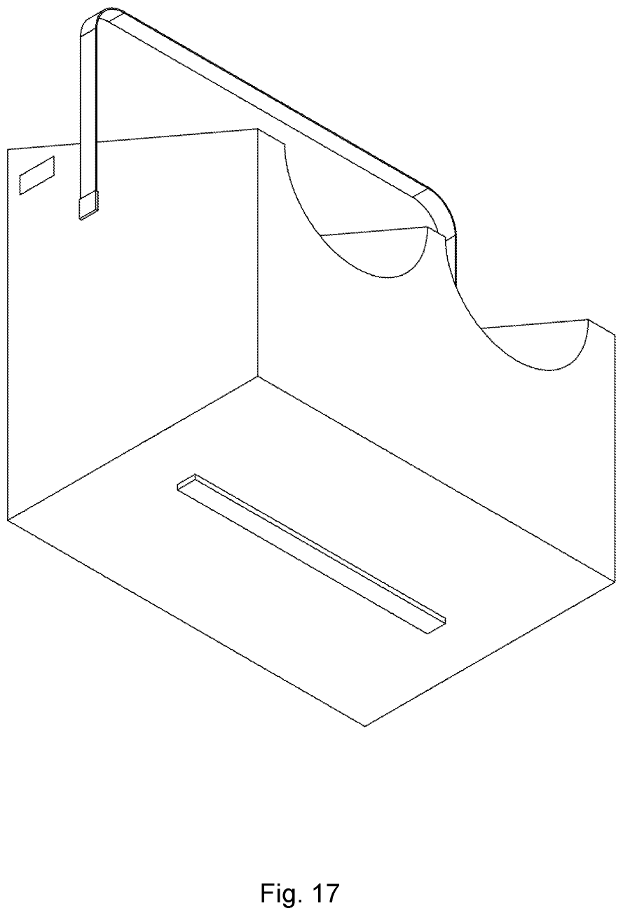

### DETAILED DESCRIPTION OF THE DISCLOSURE

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides and the like are referenced according to the views, pieces and figures presented. It should be understood, however, that the terms are used only for purposes of description, and are not intended to be used as limitations. Accordingly, orientation of an object or a combination of objects may change without departing from the scope of the disclosure.

Reference throughout this specification to “one embodiment,” “an embodiment,” “one example,” or “an example” means that a particular feature, structure, or characteristic described in connection with the embodiment or example is included in at least one embodiment of the present disclosure. Thus, the appearance of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium.

Any combination of one or more computer-usable or computer-readable media may be utilized. For example, a computer-readable medium may include one or more of a portable computer removable drive, a hard disk, a random access memory (RAM) device, a read-only memory (ROM) device, an erasable programmable read-only memory (EEPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code, or virtual code, or framework code suitable for the disclosure herein, or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“Saas”), Platform as a Service (“PaaS”), and Infrastructure as a Service (“IaaS”)), and deployment models (e.g., private cloud, community cloud, public cloud, and hybrid cloud).

### System:

With reference to the figures, an inflatable system, a patient treatment system, a shock treatment system, processes and methods of use 10 are presented. Inflatable system, a patient treatment system, a shock treatment system, processes and methods of use 10 (hereafter referred to as “inflatable medical system”, “inflatable system”, “shock system”, “elevation system”, or simply “system”) is formed of any suitable size, shape and design.

In the arrangement shown, as one example, system 10 is configured to assist a patient experiencing shock. Shock is a condition in which a person and/or patient is unable to adequately provide nutrients (generally via Oxygen through blood movement), and remove waste products (generally carbon dioxide or CO2) to their organs and tissues. This usually occurs due to a blood flow issue in shock patients. The result for a patient in shock can be dramatic in effect, such as major organ damage or death. One means of combating shock is to raise the legs of the patient or through passive leg raise (PLR). The present disclosure, system 10, provides a means for effective passive leg raise.

In the arrangement shown, as one example, system 10 achieves passive leg raise by providing an inflatable nylon container 20 (or “main body”) which elevates, supports, and also secures the legs in a position which elevates the extremities of a user above the heart of a patient. Furthermore, and said another way, the main body 20 is inflated through an inflation port 22. The inflation port being located on the membrane 24 of the main body 20. The main body 20 is stored, compactly and conveniently until needed. Once needed, a user can utilize the activation trigger 26, releasing a pre-charged volume of pressurized gas 28, from a cartridge 29, such that the main body 20 inflates to a desired size. In an alternative embodiment, the device may be configured to quickly absorb surrounding ambient air for inflation.

Furthermore, and in the arrangement shown, as one example, system 10 is configured in a particular size and shape. However, alternative sizes and shapes are hereby contemplated for use. Furthermore, the system may be configured to be adjustable to different sizes as needed by the release or addition of a particular amount of compressed gas. Once the compressed gas enters the container 20, the container inflates to a desired shape and size, and can be utilized to hold a patient's extremities, such as legs, at an elevated position. The system can also utilize straps 30 and handholds 32 for securing the patient and/or transportation and/or evacuation of a patient.

The present disclosure is configured to provide for use in the field by emergency medical services, military, civilian users, emergency rooms, operating rooms, intensive care units, and the like. System 10 is configured to deflate as well for easy repacking and reuse and/or as a disposable one time use item for convenience as may be needed, and are hereby contemplated for use.

In the arrangement shown, as one example, the system 10 may also include instructions of use. These instructions of use may be on the exterior of the storage system or may be directly on the main body of the device itself.

In the arrangement shown, as one example, inflatable medical system 10 may comprise, in the embodiment(s) depicted, a medical professional and/or user 12, a patient 14, a storage container 18, a main body 20, an inflation port 22, a membrane 24, an activation trigger 26, a release trigger 27, a pressurized gas 28, a plurality of straps 30 or nylon straps, a plurality of handholds 32, a transport sheet 34, a hook and loop securement feature 36, a plurality of compressed gas containers 40, a trigger mechanism 50, an activation feature 52, a deactivation feature 54, an instructions of use 60, a sensor system 80, a vital detection and measuring system 82, a gps feature 84, and an onboard computing and communication system 106, among other components, features, and functions.

### Device:

In the arrangement shown, as one example, system 10 includes a main body 100, extending a length from a first end 102 to a second end 104, between opposition sides 106, having a top 108 and a bottom 110.

In the arrangement shown, as one example, the main body includes a first groove 112 of the top 108 and a second groove 114 of a top 108. The top 108 is configured at an angle 116 having a shorter front or first end and a taller back or second end. This angle is configured at an idealized angle to provide for circulation to the feet or lower end of extremities while optimally promoting circulation and specifically circulation for a patient in need of that circulation via various conditions as are described herein.

In the arrangement shown, as one example, the main body also includes a first support 116, a second support 118, and a spacer 120. The spacer 120 is configured to maintain extremities at an optimal distance from one another allowing for circulation and heat exchange.

In the arrangement shown, as one example, system 10 includes an activation feature, wherein the activation feature is a pull string which releases pressurized gas. Furthermore, system 10 includes a deactivation feature; the deactivation feature configured to allow releasing pressurized air within the membrane. Said another way, the deactivation feature is a port or cap which can release air.

In the arrangement shown, system 10 includes a vital detection and monitoring feature. The vitals detection and monitoring system may include a display 86. The vital detection and monitoring system detects vitals of a patient engaged with the system, can display those vitals and/or communicate those vitals to a smart device or bluetooth paired device, and the like.

In the arrangement shown, system 10 may also include a global positioning system (GPS). The global positioning system may be configured to activate and start transmitting an emergency signal which includes information about the geographic location of the system. In this way, the system can notify others of activation and location. In one embodiment, as one example, the system is configured to transmit vital information of a patient, and the like. This may be via a radio transmission signal, a cell phone signal, an emergency transmitter, a combination and the like.

### Sensor/Detection System:

In the arrangement shown, as one example, system 10 includes a sensor system. Sensor system is formed of any suitable size, shape, and design and may include one or more sensors and/or one or more sensing technologies. In the arrangement shown, as one example, sensor system is configured to detect and communicate information related to system 10. This may include information related to the patient. This may include vital information related to the patient such as pulse, blood-oxygen levels, skin temperature, a combination thereof, and the like. This may also include global positioning for locating a patient and the like.

In addition to the above identified features, options, controls, and components, system 10 may also include other features and functionalities, among other options, controls, and components.

### In Operation/Assembly:

In one example, system 10 can be constructed using nylon fabric for a base, top, sides, and structure. The sectional components can be fused to create a uniform construction. In one example, this is achieved by heat sealing any seams to one another. In one example, and as a method of use, the main container can then be pressurized by a CO2 cartridge and trigger which activates the release of the compressed air into the hollow interior of the main body 20. In one example, the cartridge is included with the kit and is contained within the container. As another example, the cartridge is built into the main body and activated by an activation trigger. The device is packaged and stored in a deflated state until needed.

The device may come in varying sizes or may be adjustable depending on how much activation or deactivation is provided through adding or releasing compressed air into the main body of the system.

It will be appreciated by those skilled in the art that other various modifications could be made to the system, process, and method of use without parting from the spirit and scope of this disclosure. All such modifications and changes fall within the scope of the claims and are intended to be covered thereby.

What is claimed:

1. An inflatable emergency medical device, comprising:
a main body;
the main body extending a length from a first end to a second end;
the main body having opposing sides;
the main body having a membrane;
wherein the membrane is configured to trap air;
wherein the membrane is inflated with air;
wherein when the membrane is inflated a shape is formed;
wherein the shape formed is configured to elevate extremities.

2. The device of claim 1, further comprising:
a first groove;
wherein the first groove is configured to receive a first extremity of a patient;
a second groove;
wherein the second groove is configured to receive the second extremity of the patient.

3. The device of claim 1, further comprising:
a first support;
a second support;
a spacer;
a first groove;
wherein the first groove is configured to receive a first extremity of a patient;
a second groove;
wherein the second groove is configured to receive the second extremity of the patient;
wherein the first groove is formed by an indentation between the first support and the spacer;
wherein the second groove is formed by an indentation between the spacer and the second support.

4. The device of claim 1, further comprising:
a medical professional;
a patient.

5. The device of claim 1, further comprising:
a storage container;
wherein the storage container is configured to store the device therein for transporting the device and easily stowing the device.

6. The device of claim 1, further comprising:
a vitals detection system;
wherein the vitals detection system activates when the system is activated;
wherein the vitals detection system detects vitals of a patient engaged with the system;
a vitals display;
wherein the vitals display displays the vitals of the patient on the device.

7. The device of claim 1, further comprising:
an inflation port;
wherein the inflation port provides access from the outside of the membrane to a hollow interior, so that gas can be moved from the outside of the membrane to the hollow interior of the membrane.

8. The device of claim 1, further comprising:
an activation trigger;
wherein the activation trigger is a pull string, the pull string releasing pressurized gas into a hollow interior of the membrane;
wherein releasing pressurized gas into the hollow interior causes the membrane to fill with gas and expand to an inflated position.

9. The device of claim 1, further comprising:
a pressurized gas.

10. The device of claim 1, further comprising:
a securement strap;
wherein the securement strap is configured to strap extremities of a patient to the device.

11. The device of claim 1, further comprising:
a plurality of handholds;
wherein the handholds are configured so that medical professionals can transport a user engaged with the system;
a transport sheet;
wherein the transport sheet is included with the system so as to be available for transporting a patient or covering a patient.

12. The device of claim 1, further comprising:
a vitals detection system;
wherein the vitals detection system activates when the system is activated;
wherein the vitals detection system detects vitals of a patient engaged with the system.

13. The device of claim 1, further comprising:
a sensor system;
the sensor system configured to detect various environmental metrics;
the sensor system having a plurality of sensors.

14. The device of claim 1, further comprising:
an activation feature;
the activation feature being a pull string;
a deactivation feature;
the deactivation feature being a release port which allows air to escape the membrane.

15. The device of claim 1, further comprising:
a global positioning system.

16. An elevation system, comprising:
a main body;
the main body extending a length from a first end to a second end;
the main body having opposing sides;
the main body having a membrane;
a first groove;
a second groove;
a first support;
a second support;
a spacer;
a pressurized gas;
a securement strap;
wherein the securement strap is configured to strap extremities of a patient to the device.
an activation feature;
wherein the activation feature is a pull string, the pull string releasing pressurized gas into a hollow interior of the membrane;
wherein releasing pressurized gas into the hollow interior causes the membrane to fill with gas and expand to an inflated position;
a deactivation feature;
the deactivation feature being a release port which allows air to escape the membrane;
an inflation port;
wherein the inflation port serves as a backup feature in the event that the activation feature fails to activate the pressurized gas and cause inflation to the device, the inflation port provides for inflation from the exterior of the device by forcing gas into a hollow interior of the device.

17. The system of claim 16, further comprising:
instructions of use;
a medical professional;
a patient;
a transport sheet.

18. The system of claim 16, further comprising:
a vitals detection system;
wherein the vitals detection system activates when the system is activated;
wherein the vitals detection system detects vitals of a patient engaged with the system.

19. The system of claim 16, further comprising:
a global positioning system.

20. A method of treating a patient in medical shock;
providing an inflatable device; the inflatable device having a port for receiving a CO2 cartridge;
connecting the CO2 cartridge to the port; the port causing the pressurized gas within the CO2 cartridge to be released into a hollow interior of the inflatable device;
placing the inflatable device under the legs of a patient experiencing medical shock;
securing the patient's lower extremities to the inflatable device with a securement strap; the securement strap formed of hook and loop;
monitoring vitals of the patient as the inflatable device causes blood circulation due to an elevated position of the lower extremities of the patient cause by the inflatable device being positioned underneath the lower extremities of the patient.
